(19) United States
(12) Patent Application Publication
(10) Pub. No.: US 2025/0258372 A1
(43) Pub. Date: Aug. 14, 2025

(54) LAYERED DISPLAYS

(71) Applicant: VueReal Inc., Waterloo (CA)

(72) Inventor: Gholamreza CHAJI, Kitchener (CA)

(73) Assignee: VueReal Inc., Waterloo, ON (CA)

(21) Appl. No.: 18/996,223

(22) PCT Filed: Apr. 3, 2024
(86) PCT No.: PCT/CA2024/050425

§ 371 Date: Jan. 17, 2025

Related U.S. Application Data
(60) Provisional application No. 63/493,883, filed on Apr. 3, 2023.
(60) Provisional application No. 63/493,883, filed on Apr. 3, 2023.

(51) Int. Cl. G02B 27/01

(52) U.S. Cl. CPC G02B 27/0101; G02B 2027/0118

(57) ABSTRACT

The present disclosure discloses various methods and systems of image reflection and displays in automotive transport. In particular use of reflective surfaces, in combination with displays which may be transparent to create images that may be perceived at different distances from the reflective surface. Use of 2D and 3D is also implemented. In addition, the reflective surfaces may be semi-transparent.

### FIELD OF THE INVENTION

The present disclosure relates to image reflection and displays in automotive transport.

### SUMMARY

The present invention relates to a method to create images using a reflective surface and transparent displays, the method comprising, having a reflective surface, having at least one transparent display (first display) and a second display set behind the at least one transparent display, and using the reflective surface to create two images of the two displays that are perceived at different distances from the reflective surface.

The present invention relates to a method to create images using a reflective surface and a display, the method comprising, having a reflective surface, having at least one display, having at least two parts of the display having different distances from the reflective surface and using the reflective surface to create images wherein the at least two parts of an image are perceived or appear at two different distances.

The present invention relates to a display system to create images perceived at at least two different distances the system comprising, a reflective surface, at least one transparent display and a second display set behind the at least one transparent display and reflecting the images from the reflective surface to the viewers to create two images of the two displays that are perceived at different distances from the reflective surface.

### BRIEF DESCRIPTION OF THE DRAWINGS

The foregoing and other advantages of the disclosure will become apparent upon reading the following detailed description and upon reference to the drawings.

FIG. 1 shows a reflective surface being used to reflect the image of a display to the viewers.

While the present disclosure is susceptible to various modifications and alternative forms, specific embodiments or implementations have been shown by way of example in the drawings and will be described in detail herein. It should be understood, however, that the disclosure is not intended to be limited to the particular forms disclosed. Rather, the disclosure is to cover all modifications, equivalents, and alternatives falling within the spirit and scope of an invention as defined by the appended claims.

### DETAILED DESCRIPTION

The present disclosure describes systems and methods to create images using a reflective surface and displays.

In some applications large images at further away distances are needed. For example, in an automotive transport, such as a car, an image further on the road will be more useful due to the focus point of the driver and passengers. Also, a larger image will provide better visibility for the driver. However, the car has small space and so using large displays is not useful. In another case, different information may need to be at different distances to make it more useful.

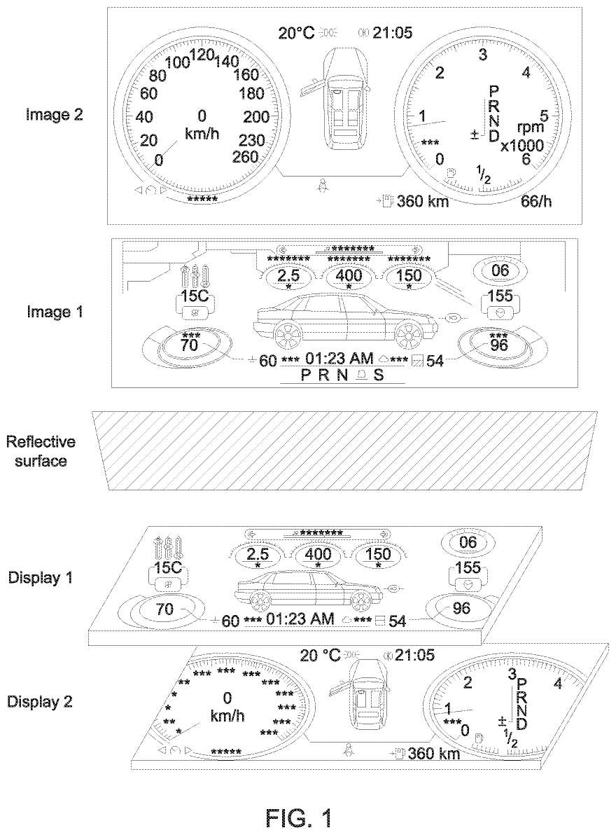

FIG. 1 shows a display system 100 providing the reflection Image 1 and Image 2 of two Displays, Display 1 and Display 2 that appear at different distances. In one related embodiment, a reflective surface is used to reflect the Image 1 and Image 2 of displays, Display 1 and Display 2 respectively to the viewers. Here, at least one transparent Display 1 is used, and a second Display 2 is set behind the transparent Display 1. For higher efficiency, Display 1 and Display 2 are aligned so that the light generating part of the pixels in second Display 2 is aligned with the transparent part of the pixels in first Display 1. Since displays are set at two different distances in reference to the reflective surface, the two images created for the two displays may be perceived at different distances from the reflective surface.

Optical material may be used between the two displays to direct the lights of the second display toward the first display. The optical material can be adhesive material, lens, micro-lens or other type of structure enhancing light coupling between second and first display.

The displays can be microLED displays.

In one case, the reflective surface is a concave mirror, so the small changes in the distance between the two displays, Display 1 and Display 2 result in larger distances between the two Image 1 and Image 2.

Other types of optical layers may be added between the two displays to adjust the distance of the two images.

The two displays can be different sizes. In one embodiment, one display is smaller and has overlap on part of the other display.

In another embodiment, the two displays may have no overlap. In this case, two different images are created on the reflective surface at two different distances without overlap or only partial overlap. In this case, the two displays do not need to be transparent.

In one related embodiment, only one transparent display is used. Here the ambient lights pass through the display and are absorbed by areas under the display. These avoid extra heat created by ambient light. Furthermore, it can enhance the display performance by improving contrast ratio.

In another case, the Reflective surface can have 2D or 3D curvature, such as the windshield of an automotive transport such as a car. Here, the displays can have a curvature following the curvature of the reflective surface so that the entire image is perceived at the same distance. This system can create the image with one or more than one display.

In another related embodiment, the display(s) can have a curvature so that different parts of the display are at a different distance from the reflective surface. This will move different parts of the images to a different distance from the reflective surface. This system can use one or more than one display.

The reflective surface can be semi-transparent to create one or two augmented images on different distances. In another case, the reflective surface can be fully opaque to enhance the image quality.

In one related embodiment, a transparent display is in front of the reflective surface. This display creates an image in the same plane as the reflective surface. In another embodiment, the reflective layers can be part of the transparent displays.

In one related embodiment the two displays are not stacked. Here, the displays are facing the reflective layers from different locations. In one related embodiment, the two displays are facing each other, and one display has a second reflective layer or is on top of a second reflective surface. The second reflective layer reflects the image from the one or both displays into the first reflective layer that creates the image for the viewer.

In one related embodiment a reflective system comprising a reflective surface having at least one Display 1 and at least two parts of the display have different distances from the reflective surface. The reflective surface to create images where at least two parts of the image are perceived at two different distances. The display or reflective surface is curved to create at least two different distances. In another related case, two displays are set at two different distance to create the two different part of the images.

While the present disclosure is susceptible to various modifications and alternative forms, specific embodiments or implementations have been shown by way of example in the drawings and will be described in detail herein. It should be understood, however, that the disclosure is not intended to be limited to the particular forms disclosed. Rather, the disclosure is to cover all modifications, equivalents, and alternatives falling within the spirit and scope of an invention as defined by the appended claims.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. A display system to create images perceived at least two different distances the system comprising:
a reflective surface;
at least one transparent display and a second display set behind the at least one transparent display; and
reflecting the images from the reflective surface to the viewers to create two images of the two displays that are perceived at different distances from the reflective surface,
wherein the two displays have no overlap and wherein the two displays are not transparent.

14. The system of claim 13, wherein a reflective surface is a concave mirror, so that small changes in a distance between the two displays result in larger distances between the two images.

15. The system of claim 13, wherein the reflective surface has a 2D or a 3D curvature.

16. The system of claim 13, wherein the 2D or the 3D curvature corresponds to a windshield of a car, wherein further the two displays have a curvature following the curvature of the reflective surface so that the entire image is perceived at a same distance.

17. The system of claim 13, wherein the displays are aligned so a part of pixels in the second display creating image is set behind the part of the pixels in the first display that is transparent.

18. The system of claim 13, where optical material is used to direct the light from the second display toward the first display.

19. The system of claim 13, wherein the two displays are of different sizes.

20. The system of claim 13, wherein additional optical layers are added between the two displays to adjust the distance of the two images.

21. (canceled)

22. The system of claim 13, wherein two different images are created on the reflective surface at two different distances without overlap or only partial overlap.

23. (canceled)

24. The system of claim 13, wherein only one transparent display is used wherein ambient lights pass through the transparent display and are absorbed by areas under the transparent display.

25. The system of claim 24, wherein having only one transparent display enhances the contrast ratio.

26. The system of claim 15, wherein the displays have a curvature following the curvature of the reflective surface so that an entire image is perceived at a same distance.

27. The system of claim 26, wherein the system creates the image with one or more than one display.

28. The system of claim 15, wherein the displays have a curvature so that different parts of the displays are at a different distance from the reflective surface.

29. The system of claim 28, wherein different parts of the images are moved to a different distance from the reflective surface.

30. The system of claim 13, wherein the reflective surface is semi-transparent to create one or two augmented images on different distances.

31. The system of claim 13, wherein the transparent display is in front of the reflective surface creating an image in a same plane as the reflective surface.

32. The system of claim 13, wherein the reflective layer is part of the transparent display.
